(19) United States
(12) Patent Application Publication
(10) Pub. No.: US 2003/0056584 A1
(43) Pub. Date: Mar. 27, 2003

(54) Mass flow sensor and measuring apparatus

(76) Inventor: Tae-Won Park, Seoul (KR)

Correspondence Address: STRAUB & POKOTYLO, 1 BETHANY ROAD, SUITE 83, BUILDING 6, HAZLET, NJ, 07730, US

(21) Appl. No.: 09/964,593

(22) Filed: Sep. 27, 2001

(51) Int. Cl. G01F 1/68

(52) U.S. Cl. 73/204.11

(57) ABSTRACT

The present invention discloses a mass flow sensor and a measuring apparatus, and more particularly, to a mass flow sensor comprising a structure that mounts and/or houses a hybrid ceramics having a combined construction including a boundary 4 dividing a static temperature coefficient thermistor 2 and, as an insulator, a supporting body 3; with electrodes 5 and 5′ and the insulation coating and thermal conductive metal, characterized in that it electrically insulates outer side of the thermistor 2 with the supporting body 3 in order to equip the resister thermistor having greater static temperature coefficient than existing platinum or nickel elements while self-limited exothermic temperature within the conduit 11, enables the temperature sensor and mass flow sensor to directly detect fluid inside of the conduit to achieve speedy detection and accurate measurement of flow, and to minimize heat loss from terminal portions and to solve decrease of sensing capability of sensor caused from latent heat of the insulator; and a measuring apparatus comprising the above mass flow sensor together with temperature compensating device to detect variation of mass depending on temperature of fluid.

### BACKGROUND OF THE INVENTION

1. Field of the Invention

The present invention is directed to a mass flow sensor and a measuring apparatus, and more particularly, to a mass flow sensor comprising a structure that mounts and/or houses a hybrid ceramics having a combined construction including a boundary dividing a static temperature coefficient thermistor and, as an insulator, a supporting body with electrodes, the insulation coating and thermal conductive metal, characterized in that it electrically insulates outer side of the thermistor with the supporting body in order to equip the resister thermistor having greater static temperature coefficient than existing platinum or nickel elements while self-limited exothermic temperature within the conduit, enables the temperature sensor and mass flow sensor to directly detect fluid inside of the conduit to achieve speedy detection and accurate measurement of flow, and to minimize heat loss from terminal portions and to solve decrease of sensing capability of sensor caused from latent heat of the insulator; and a measuring apparatus comprising the above mass flow sensor together with temperature compensating device to detect variation of mass depending on temperature of fluid.

2. Background of the Related Art

Conventionally known mass type flow detection apparatus are, for example, the flow detection device using hot film or hot wire sensor and the mass measurement device to indirectly determine the mass of fluid by attaching ceramic semiconductor elements on outer surface of the conduit.

The above described hot-film type or hot-wire type flow detection device has favorable measurement accuracy, however, has a problem of higher production cost because the measuring elements of the device are prepared as a liner type material having about 10 μm of outer diameter or a thin film having several μm of thickness.

Furthermore, it is in trouble to practically utilize the device owing to a difficulty in electrically insulating the hot-wire or hot-film in case of fluid in liquid state, although flow rate of gas can be detected.

For any measurement circuit comprising hot-wire or hot-film elements made of platinum or nickel with low static temperature coefficient to show low sensitivity, it requires to construct the static temperature mode of measurement circuit in order to prevent ignition caused from heat generation.

In case of the static temperature mode circuit, a thermistor is often applied as a structural element of Wheatstone bridge and is operated to generate output voltage at both ends of the reference resistor caused from the balance of bridge to be broken, when the temperature of thermistor is reduced dependent on the increase of flow rate by applying to input terminals of the bridge with the voltage equal to the integrated value of output voltage from the bridge by an amplifier; to calculate amount of the electric energy consumed in the thermistor from current and voltage values of the reference resistor; and to recover the equilibrium state of bridge by increasing the application voltage from the bridge at non-equilibrium state of the bridge. Such operation is to control temperature of thermistor causing a problem of higher production cost.

With regard to mass flow detection apparatus using static temperature coefficient ceramic semiconductors, there are examples described in known arts including (1) U.S. Pat. No. 5,216,918; (2) Japanese Laid-Open Pub. No. 63-210666; (3) Japanese Laid-Open Pub. Nos. 7-91998 and (4) 5-306947; (5) U.S. Pat. No. 4,413,514.

Among these publications, (1), (3) and (5) are used without insulator, especially, (1) was disclosed as a representative technique to employ the static temperature coefficient thermistor without insulator. Such patent introduced an apparatus is equipped with PTC elements to thermally contact with outer wall and temperature sensors not self-generating heat within the conduit to detect variation of fluid based on resistance changes of the PTC elements and signals in association with the temperature sensors, and a detection method by the apparatus. The sensors are composed of barium titanate (BaTiO₃) or strontium titanate (SrTiO₃) as the PCT elements and other additives to detect the resistance changes of the PTC elements.

On the other hand, technical application set forth in (3) is also directed to two disc type thermistors installed in the conduit to form bridge circuits and to measure mass flow rate from the difference between both of circuits, while (5) discloses a detection apparatus comprising two kinds of thermistors such as NTC and PTC thermistors without insulator which has a disadvantage of lowering heat detection performance due to heat loss at terminal portions of the thermistor since the entire sensor is consisted of the thermistor.

Furthermore, (2) and (4) relate to conventional mass flow sensors having insulator coated with static temperature thermister, as shown in FIGS. 8 and 9.

Mass flow sensor 30 set forth in (2) which is described in Japanese Laid-Open Pub. No. 63-210666 (FIG. 8) comprises ball shape of electrical insulator 31; a first thin film electrode 32 formed on surface of said insulator 31; a static temperature thin film thermistor 33 regularly formed on surface of said first thin film electrode 32; a second thin film electrode 34 formed on surface of said thermistor 33 to determine flow rate of fluid, wherein the insulator 31 is coated with a bottom electrode, followed by such thin PTC thermistor 33 applied above the bottom electrode and then an upper electrode covering the PTC thermistor. The cited application also describes that a construction of a bridge circuit together with such sensor coated with the upper electrode can allow the flow rate of fluid passing through such sensor 30 to be detected from output of a feedback amplifier tending to keep a balance of bridge.

As shown in FIG. 9, there is described in Japanese Laid-Open Pub. 5-306947, a flow rate probe 35 having lead cord 40 and protection cord 41 at lower part of the probe and fixed on a holder 42 which comprises an electrical insulating support substrate 36 and a heat-sensing resister 37 attached on surface of said substrate 36 wherein such resister 37 is consisted of a principle heat-sensing resister 38 made of such a material as to have variable resistance depending on temperature; and heat sink portion 39 made of such a material as to have larger resistance-temperature coefficient than of said resister 38. Such heat-sink portion 39 is arranged near to such heat-sensing resister 38 at the supporting portion of said probe 35. The probe supplements and reduces heat loss at terminal portions thereof by covering the substrate with NTC as both of a heat-sensitive sensor and a sub-temperature coefficient resister, simultaneously, and covering a portion near to terminals with PTC as a static temperature coefficient resister.

Nevertheless, conventionally known arts described above have a problem, that is, of less heat capacity as the thermister is in a thin film to be influenced by latent heat generated from ball type electrical insulator (made of aluminum) 31 as shown in FIG. 8, or another insulator substrate 4 as shown in FIG. 9, thereby to lead the detection time to be extended and the measurement of mass flow to be uncertain and/or to be inaccurate when the temperature of fluid is varied.

### SUMMARY OF THE INVENTION

Accordingly, in order to solve the limitations of the related art mention above, the present invention relates to a mass flow sensor and a measuring apparatus, and more particularly, to a mass flow sensor comprising a structure that mounts and/or houses a hybrid ceramics having a combined construction including boundary to divide a static temperature coefficient thermistor and, as an insulator, a supporting body with electrodes, the insulation coating and thermal conductive metal, characterized in that it isolates outer side of the thermistor with the supporting body in order to equip the resister thermistor having greater static temperature coefficient than existing platinum or nickel elements while self-limited exothermic temperature within the conduit, enables the temperature sensor and mass flow sensor to directly detect fluid inside of the conduit to achieve speedy detection and accurate measurement of flow, and to minimize heat loss from terminal portions and to solve decrease of sensing capability of sensor caused from latent heat of the insulator; and a measuring apparatus comprising the above mass flow sensor together with temperature compensating device to detect variation of mass depending on temperature of fluid.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a perspective view of a mass flow sensor as an embodiment according to the present invention;

FIG. 2 illustrates the structure of a circuit for measuring constant voltage according to the present invention;

FIG. 3 illustrates a cross-sectional view of a measuring apparatus for detecting mass flow according to the present invention;

FIG. 4 illustrates a cross-sectional view of an liquid detecting sensor arranged in such measuring apparatus set forth in FIG. 3 according to the present invention;

FIG. 5 illustrates a cross-sectional view of a gas detecting sensor arranged in such measuring apparatus set forth in FIG. 3 according to the present invention;

FIG. 6 shows the measuring apparatus in operating state as an embodiment according to the present invention;

FIG. 7 illustrates a resistance variation graph dependent on temperature of the mass flow sensor according to the present invention;

FIG. 8 illustrates a cross-sectional view of an example of the conventional mass flow sensors; and

FIG. 9 illustrates a cross-sectional view of another example of the conventional mass flow sensors.

### DESCRIPTION OF NUMERICAL REFERENCE FOR PARTS

1: mass flow sensor

2: thermistor

3: joint supporting body for mass flow sensor

4: boundary

5,5′: electrode

6: temperature sensor

7: power connection wire for temperature sensor

8: power connection wire for mass flow sensor

9: supporting body for mass flow sensor

10: circuit protection case

11: conduit

12: supporting pipe for mass flow sensor

13: sensor protection cover

14: insulating material for protecting sensor

15: nipple for securing mass flow sensor

16: insulating material for protecting mass flow sensor

17: supporting body fixing nut

18: compressing ring

19: nipple

20: insulating material

21: point just before the curie point of sensor

22: resistance point at power applying

### DETAILED DESCRIPTION OF THE INVENTION

Reference will now be made in detail to the preferred embodiments of the present invention, examples of which are illustrated in the accompanying drawings.

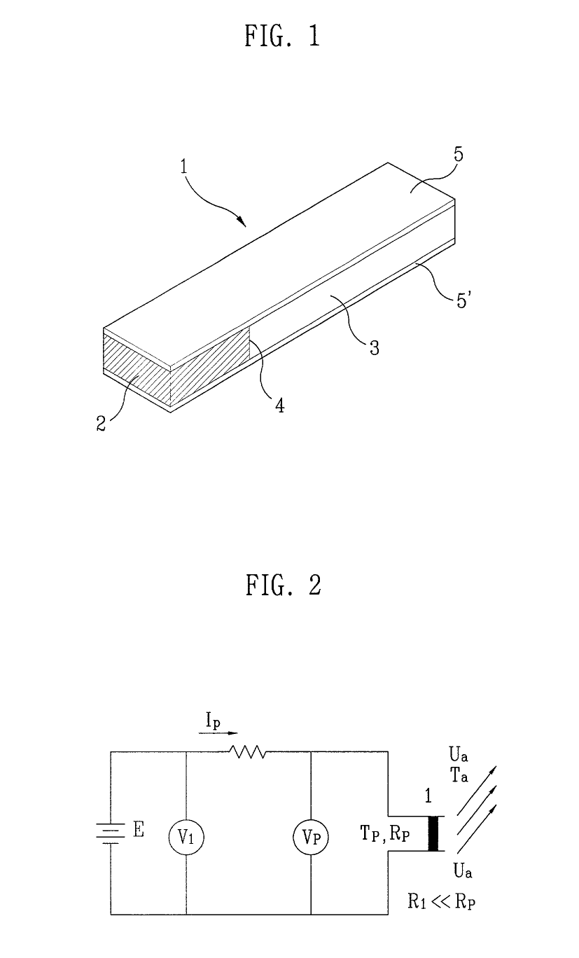

FIG. 1 is a perspective view to illustrate a mass flow sensor of the present invention.

As shown in figures, the mass flow sensor of the present invention, the sensor 1 has a boundary 4 dividing the thermistor 2 as a resistor and a supporting body 3 as an insulator; is consisted of an integrated combination structure of hybrid ceramics wherein upper and lower sides of the ceramics are equipped with electrodes 5 and 5′ and then entirely coated with insulating film excluding terminal portions, and optionally, is formed by mounting and/or housing it with high thermal-conductive metal elements.

Such electrodes 5 and 5′ are for passing electric current to the thermistor 2 and preferably formed over the entire area of the sensor; minimize heat loss at terminal parts by forming along narrow width of the supporting body; in order to prevent cracks and/or variations of volume from generating around the boundary 4 of the thermistor 2 and the supporting body 3, the thermistor 2 favorably has a thermal expansion coefficient approximately equal to that of the supporting body 3.

Hereinafter, described is above said mass flow sensor 1 for constructional components thereof and a procedure to manufacture it.

A static temperature coefficient thermistor 2 (hereinafter referred to “thermistor”) is made of perovskite base solid solution generally defined as a formula of ABO₃, in which A represents Ca, Sr, Ba or Pb, B represents Ti or so on. For semi-conductive thermistor, provided are additives including metallic oxides or precursors selected from Mn, Mg, Al, Si, Ti, Zr, W, etc. other than Y, Sb, Nb, Nd and La elements.

In order to have a lattice constant substantially same to that of said thermistor 2 and desired thermal expansion coefficient, said perovskite thermistor composition further includes at least one of chemical ingredient to prepare a supporting body 3 as an insulator.

Such composition are, for example, as follows:

(1) ABO₃ oxides or precursors identical to ABO₃ base thermistor 2 to be useable (wherein A and B are possibly at least one or more components based solid solution).

(2) Oxide or precursor composition including ABO₃ oxides or precursors identical to a principle component system of the thermistor 2, in addition with, 10 mol % or less of at least one element selected from Y, Sb, Nb, Nd, La, Mn, Mg, Al, Si, Ti, Zr, W, etc.

(3) Oxide or precursor composition including less or excess contents than proper value of the additives (for example, Y, Sb, Nb, Nd, La, Mn, Mg, Al, Si, Ti, Zr, W) to express semi-conductive effect of the thermistor 2.

(4) Composition including at least one component less than or over the desired numbers of additive composition for the thermistor 2.

### EXAMPLE 1

For a resistor thermistor 2 having a main component of barium titanate (BaTiO), single component or its precursor are employed.

Otherwise, at least one of silicone, aluminum, magnesium, titanium, manganese, zirconium in oxides state or precursors thereof such as carbonates may be useable in the production of thermistor.

With regard to the preparation of hybrid ceramics, first, raw materials of the thermistor 2 and the supporting body 3 are simultaneously charged into their respective molds to execute the press molding process. The obtained products are under sintering process at more than 1200° C. for 30 minutes or more, then cooled to result in an integrated hybrid ceramics. On both sides of the ceramics, ohmic paste made of silver, nickel, aluminum, zinc or the like is printed and baked by means of screen patterned of electrode and terminals by general printing techniques to form the electrode 5 and 5′. Thereafter, the obtained electrodes are entirely coated with polymeric insulating materials such as silicone, excluding end parts of their terminals to produce the mass flow sensor 1.

Optionally, the mass flow sensor for liquid flow is preferably adhered by thin sheets of copper, stainless steel or aluminum having improved thermal conductivity, then welded and sealed to provide a mounting or a housing form for the sensor.

### Example 2

Said molding procedure is particularly executed as follows:

The molded product is added with barium titanate in single component or its precursor or at least one of aluminum, magnesium, titanium, manganese or zirconium oxides or their precursors such as carbonates to form a mixture; the mixture is dissolved in solvents such as water, alcohol, acetone or like to form a slurry; then the insulator portion is immersed in the slurry to practice the deposition-coating or applied with the slurry by known means of spray, brush or printing technique sufficient to diffuse the slurry into the insulator portion. Afterward, further treatment is carried out in the same manner as in Example 1 to produce the desired mass flow sensor 1.

Instead of barium titanate, other oxides or precursors in forms of perovskite based single components or solid solutions including strontium titanate, calcium titanate, lead titanate, calcium tungstate can be employed.

The obtained product is cut to form rectangular pieces by 5 m width×3 m length×1 mm thickness of dimension and composed of thermistor by ⅓ of longitudinal portions and the rest ⅔ portion being of the supporting body.

Principle ingredient of the thermistor 2 is a solid solution of barium titanate or lead titanate. This powdery material is added with PVA as a binder to prepare the granule type material, followed by charging the granule material for forming the thermistor into ⅓ portion of the cast mold while another granule material for forming the insulator is filled in the rest ⅔ portion of said cast mold and press molded at the same time to produce the board product in a square form.

The powder to be molded is separately charged into a Feeder cup and the cast mold divided by a separating membrane, then press-molded after removing the membrane. Different compositions to form the insulator are prepared and practiced in the same manner described above. The formed specimen is under the heat treatment at 1,250 to 1,350° C. for 30 minutes to 2 hours and cooled.

The sintered specimen is made of hybrid ceramics well separated into the static temperature coefficient thermistor 2 and the supporting body 3 as the insulator having a resistance of 100MΩ.

After printing both of upper and lower sides in thickness direction including the thermistor 2 and the supporting body 3 with the electrode and terminals, the entire portion excluding the terminal portions coupling the main body and the electric circuit is coated with insulating polymer or silicone and glass membranes.

As a result of measuring the specific resistance differences depending on temperature of the mass flow sensor 1, it was found that the thermistor has the physical property suitable as the static temperature coefficient thermistor so that said thermistor can detect even 1.0 change of temperature in an area showing sharp gradient and linearity which is sufficient to use it as the mass flow sensor.

Further, the mass flow sensor 1 for measuring liquid flow is prepared by insulation-coating and mounting or housing the sensor with thin sheets of copper, SUS or aluminum having favorable thermal-conductivity by means of welding process, after drawing the terminal lead line.

FIG. 2 shows the constant voltage circuit according to the present invention. As shown in the figure, the circuit is composed of the sensor having extremely high static temperature coefficient as an element of the circuit and applied with the constant voltage

As applied the constant voltage, if the wind velocity Ua is generated, the sensor can calculate Ua in association with energy loss caused from convection current and said wind velocity.

In order to detect current value, a reference resister is coupled to the sensor 1 in series. By measuring voltage E between both ends of such resister to obtain the current IP applied to the sensor 1 and a pure voltage, it is possible to calculate resistance value of said sensor and amount of the electrical energy consumed in said sensor. Equilibrium equations defined on the basis of consumed electric energy and amount of heat capacity loss caused from convection current are:

Electric energy=effect of convention (Eq. 1)

Electric energy=(net voltage applied by sensor VP)×current passed through sensor IP) (Eq. 2)

$$Convection calories = ( effective cross \text{-} sectional area under convection state ) ( convection factor ) \{ ( temperature of sensor ) \text{-} temperature of air \} \qquad ( Eq . 3 )$$

Convection factor=(experimental factor 1)+(experimental factor 2)(velocity of air) King's law (Eq. 4)

Among the above described equations, the temperature of sensor is deduced from the resistance of sensor and both of the experimental factors are in advance calculated by experimental procedure. Therefore, the velocity and flow rate of fluid can be known if the temperature of fluid is further measured.

As illustrated in FIG. 2, assuming that current resistance is R₁<<R₂V₁ is applied with a voltage same to E when a constant voltage applies to E of the circuit. Also, Vp should be constant with no change of its value so that it can form a constant voltage sensor.

In case of zero (non-flow) flow rate state, the circuit is set up to allow Vp to continue its constant voltage. Although Vp may vary if the wind velocity is generated, it can be recovered and under constant state by compensating it with V₁. Introduced is that the constant voltage mode of driving operation measures the wind velocity by finding out the correlation of the power consumed by the generation of wind velocity and such wind velocity.

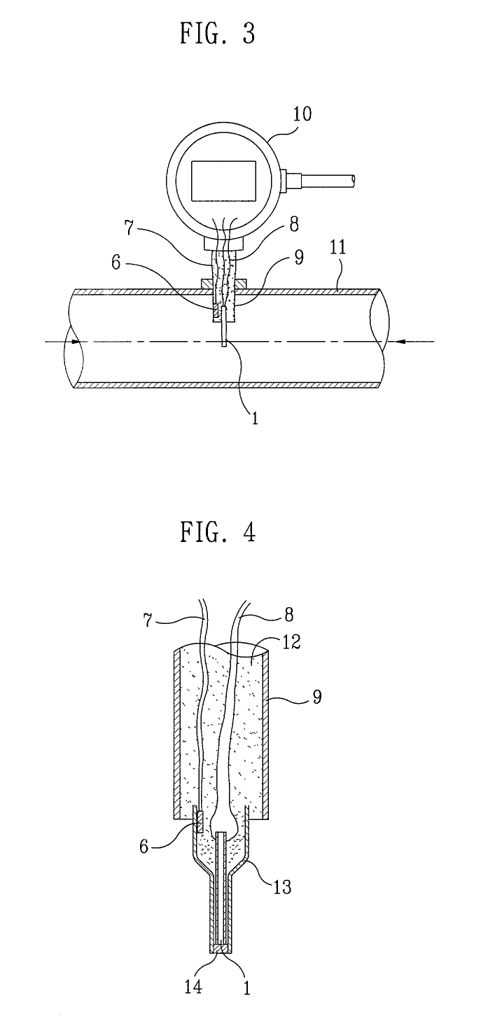

Furthermore, FIG. 3 illustrates a cross-sectional view of the measuring apparatus under use state, which comprises the mass flow sensor 1 installed at front end of the supporting body 9 for mass flow sensor to detect mass flow of the fluid passing through the conduit 11; inside of such supporting body 9 provided is a temperature sensor 6 having a power connection wire 7 to be coupled with another power connection wire for such sensor 1 for connecting both of such wires to a circuit within a protection case 10.

FIG. 4 shows another cross-sectional view of the liquid detection sensor of the measuring apparatus according to the present invention. Such measuring apparatus comprises the mass flow sensor 1 installed at front end of the supporting pipe 12 within the supporting body 9 and protected by a protrusion type cover 13 for protecting the sensor and, at its very front end part, filled with the insulating material 14 for protecting the sensor 1.

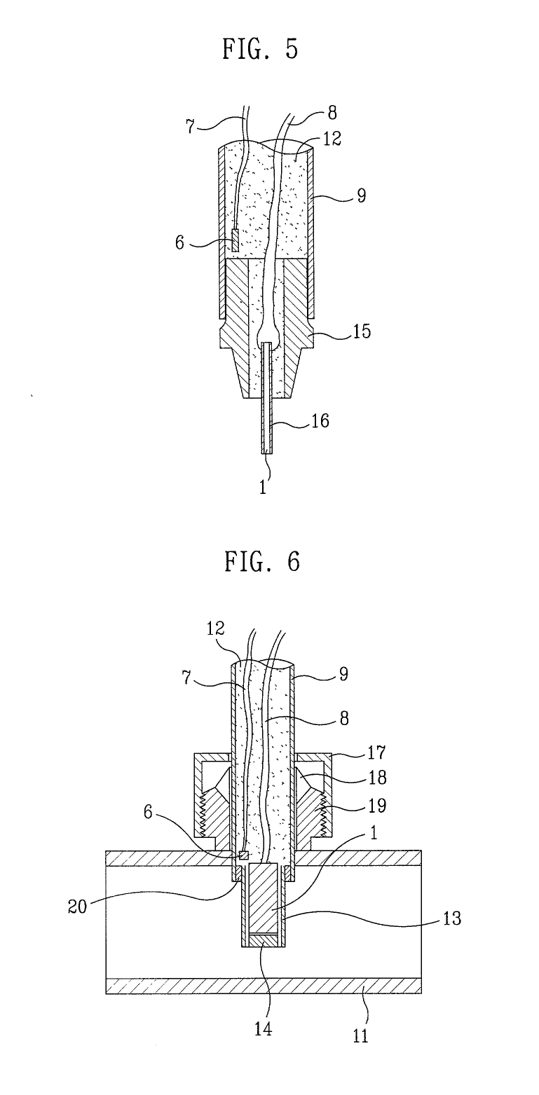

FIG. 5 shows a cross-sectional view of the gas detection sensor of the measuring apparatus according to the present invention. Such measuring apparatus comprises the mass flow sensor 1 covered by the insulating material 16 for protecting such sensor and secured in a nipple 15 equipped to the supporting body 9, which is a structural feature of the apparatus different from the previous one of FIG. 4.

FIG. 6 illustrates the measuring apparatus in operating state as an embodiment according to the present invention. Such measuring apparatus having the mass flow sensor 1 installed at front end of the supporting body 9 is equipped in the conduit 11; in which said sensor 1 is protected by the protection cover 13 and, at its front portion, filled with the insulator 14. Such apparatus further comprises the insulating material 20 interposed between the front end part of the supporting body 9 and the protection cover 13; the supporting body being hardly secured to the conduit 11 through a fixing nut 17 for the supporting body 9, a compressing ring 18 and a nipple 19 to couple it to pipe arrangement.

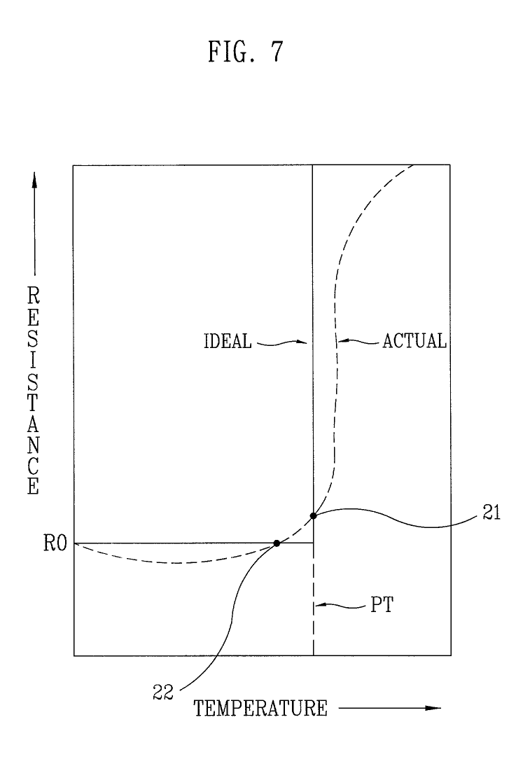

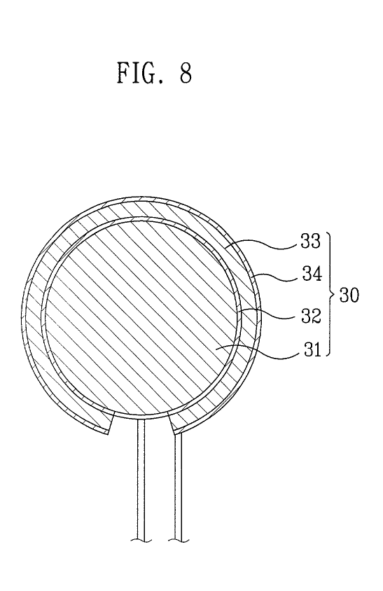

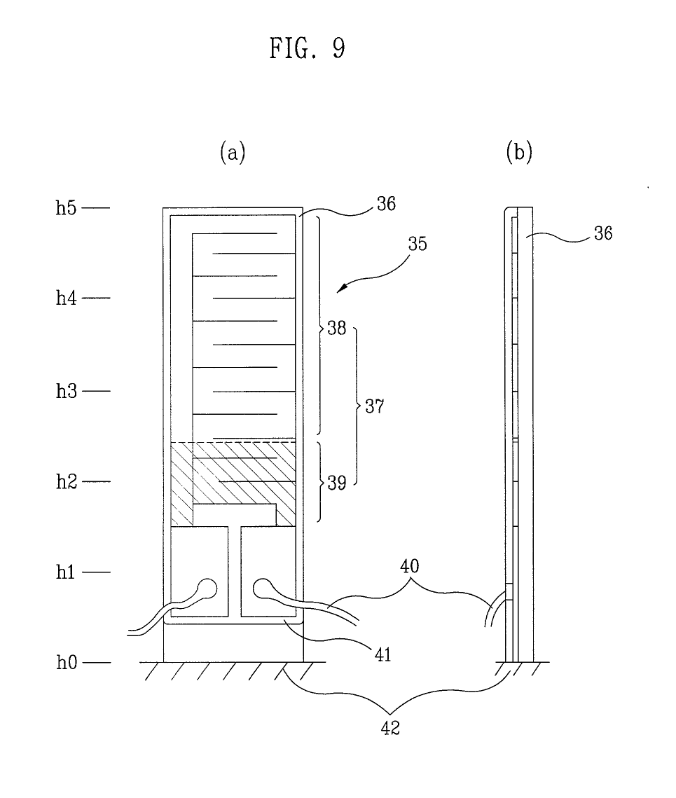

FIG. 7 illustrates a resistance variation graph dependent on temperature of the mass flow sensor according to the present invention.

As shown in FIG. 7, the resistance 22 forms S type curve depending on the increase of temperature as depicted in the dotted line and has PT Curie point when the sensor 1 having a resistance Ro at ordinary temperature is power applied. It is noticeable that the resistance is modified by more than 1,000 times around the Curie point thereby acts as a conductive material at below the Curie point while, in case of above the Curie point, serves as an insulator and shows automatic switching function.

It will be understood that the measuring apparatus according to the present invention practically accomplishes unique and beneficial features that applies constant voltage to keep up the area above Curie point and takes advantage of PTC static temperature characteristic; the principle of which the resistance is lowered in case the temperature decreases due to heat loss caused from high flow rate while the resistance raises to block the electric current and to sustain the constant temperature if the temperature increases to reach the Curie point.

As illustrated above, the mass flow sensor according to the present invention have advantages and conveniences in the related application by comprising a structure that mounts and/or houses a hybrid ceramics having a combined construction including a boundary dividing a static temperature coefficient thermistor and, as an insulator, a supporting body with electrodes, the insulation coating and thermal conductive metal, characterized in that it isolates outer side of the thermistor with the supporting body in order to equip the resister thermistor having greater static temperature coefficient than existing platinum or nickel elements while self-limited exothermic temperature within the conduit, enables the temperature sensor and mass flow sensor to directly detect fluid inside of the conduit to achieve speedy detection and accurate measurement of flow, and to minimize heat loss from terminal portions and to solve decrease of sensing capability of sensor caused from latent heat of the insulator. Additionally, It is expected that the measuring apparatus comprising the above mass flow sensor together with temperature compensating device to detect variation of mass depending on temperature of fluid also accomplishes beneficial features including practical use of the apparatus and reduction of circuit production cost as compared with conventional arts.

The forgoing embodiments are merely exemplary and are not to be construed as limiting the present invention.

The description of the present invention is intended to be illustrative, and not to limit the scope of the claims. Any alternatives, modifications, and variations will be apparent to those skilled in the art.

What is claimed is:

1. A mass flow sensor comprising a boundary 4 dividing the thermistor 2 as a resistor and a supporting body 3 as an 5 insulator and consisting of an integrated combination structure of hybrid ceramics; wherein upper and lower sides of the ceramics are equipped with electrodes 5 and 5′ then entirely coated with insulating film excluding terminal portions, and optionally, is formed by mounting and/or housing it with high thermal-conductive metal elements.

2. The mass flow sensor according to claim 1, said thermistor 2 is made of perovskite base solid solution generally defined as a formula of ABO₃ (in which A represents Ca, Sr, Ba or Pb, B represents Ti or so on) and, for semi-conductive thermistor, metallic oxides or precursors of elements selected from Y, Sb, Nb, Nd, La, Mn, Mg, Al, Si, Ti, Zr, W and the like.

3. The mass flow sensor according to claim 1, said supporting body 3 comprises any one of the following compositions; (1) ABO₃ oxides or precursors identical to ABO₃ base thermistor 2 to be useable (wherein A and B are possibly at least one or more components based solid solution), (2) oxide or precursor composition including ABO₃ oxides or precursors identical to a principle component system of the thermistor 2, in addition with, 10 mol % or less of at least one element selected from Y, Sb, Nb, Nd, La, Mn, Mg, Al, Si, Ti, Zr, W or the like, (3) oxide or precursor composition including less or excess contents than proper value of the additives (for example, Y, Sb, Nb, Nd, La, Mn, Mg, Al, Si, Ti, Zr, W) to express semi-conductive effect of the thermistor 2, (4) composition including at least one component less than or over the desired numbers of additive composition for the thermistor 2.

4. A measuring apparatus comprising a mass flow sensor 1 installed at front end of a supporting body 9 for mass flow sensor to detect mass flow of the fluid passing through a conduit 11; wherein a temperature sensor 6 having a power connection wire 7 is provided inside of such supporting body 9 to be coupled with another power connection wire for said sensor 1 for connecting both of said wires to a circuit within a protection case 10.

5. A measuring apparatus comprising a mass flow sensor 1 installed at front end of a supporting pipe 12 within the supporting body 9 to detect mass flow of the fluid;
wherein it is protected by a protrusion type cover 13 for protecting the sensor and, at its very front end part, filled with the insulating material 14 for protecting the sensor 1.

6. A measuring apparatus comprising a mass flow sensor 1 installed at front end of a supporting pipe 12 within the supporting body 9 to detect mass flow of the fluid; wherein it is covered by the insulating material 16 for protecting such sensor and secured in a nipple 15 equipped to the supporting body 9.

7. A measuring apparatus comprising a mass flow sensor 1 installed at front end of the supporting body 9 for mass flow sensor to detect to detect mass flow of the fluid passing through a conduit 11; wherein said sensor 1 is protected by the protection cover 13 and, at its front portion, filled with the insulating material 14 and has another insulating material 20 interposed between the front end part of the supporting body 9 and the protection cover 13; the supporting body 9 is rigidly secured to the conduit 11 through a fixing nut 17 for the supporting body 9, a compressing ring 18 and a nipple 19 to couple it to pipe arrangement.
